(19) United States
(12) Patent Application Publication
(10) Pub. No.: US 2002/0156816 A1
(43) Pub. Date: Oct. 24, 2002

(54) Method and apparatus for learning from user self-corrections, revisions and modifications

(76) Inventors: Mark Kantrowitz, Pittsburgh, PA (US); Ray Pelletier, Pittsburgh, PA (US); Evan Bernstein, Freehold, NJ (US)

Correspondence Address: Richard L. Byrne, Webb Ziesenheim Logsdon Orkin & Hanson, P.C., 700 Koppers Building, 436 Seventh Avenue, Pittsburgh, PA, 15219, US

(21) Appl. No.: 09/782,449

(22) Filed: Feb. 13, 2001

(51) Int. Cl. G06F 15/00

(52) U.S. Cl. 707/530

(57) ABSTRACT

Disclosed is a computer-assisted method for learning from a user's manipulations to text in a document. Changes are made to current text resulting in transformed text. Based on the changes, a rule is devised. The rule is saved for future use. An apparatus for performing this computer-assisted method is also disclosed.

### BACKGROUND OF THE INVENTION

1. Field of the Invention

This invention relates to revising text and, more particularly, to the correction, revision, and modification functions of word processing programs.

2. Description of the Prior Art

Current word processing systems observe a user's behavior and invoke functionality in response to actions from the user, but they do not learn from the actions of the user. They might exhibit behavior that appears to be intelligent, such as spelling correction and grammar correction, but their capabilities do not change over time and they do not adapt to the user. The rules that govern their operation are fixed and unchanging, except when explicitly changed by the user (e.g., by adding a word to a user dictionary).

None of the prior art learns new rules or exceptions to rules from the user's behavior in revising the document. None of the prior art considers the context in which the changes occur. Some of the prior art observes the user's actions in highly constrained choice situations to optimize performance by reweighting or reorganizing the system's existing capabilities. These systems, however, do not introduce new capabilities. Some of the prior art monitors the text typed by a user, but does not use the text before and after the modifications to invoke intelligent behavior or learn new behavior. The capabilities are focused on the new text typed by the user and do not consider the old text or the pairing of new text with old text.

Some of the prior art monitors changes made by the user, but only to mark the changes or permit the changes to be undone. The content of the changes does not invoke intelligent behavior or yield new or improved future behavior. For example, change bars and revision marks are a common word processing facility for comparing two versions of a document and tracking changes as they occur. However, the only action taken by a change-tracking system is to mark changes for later display, typically underlines and strikethroughs in the body and vertical bars in the left margin. This facility does not consider the content of the modifications. An undo facility tracks changes in order to restore the text to its unmodified state. The undo facility does not exploit the changes for invoking or learning intelligent behavior.

### SUMMARY OF THE INVENTION

It is an object of the present invention to provide a method and apparatus in word processing systems for learning from a user's self-corrections, revisions, and modifications.

Accordingly, we have developed a method and apparatus for observing a user's behavior, learning rules based on the behavior, and invoking the learned rules in response to future user actions.

The present invention observes and learns from a user's own corrections, revisions, and modifications. It learns new rules and exceptions to existing rules to invoke intelligent behavior, to improve the accuracy of its tools, to modify future behavior, and to optimize its future performance to reflect the user's personal preferences. All of this occurs simply by observing the user, without requiring explicit instruction by the user. The more the user works with the word processing software, the more intelligent it becomes. It is a much more active process and operates on a much finer scale than the prior art.

The present invention monitors the user's actions and learns from the changes a user makes in editing his or her own text. A word's state before and after the user's modifications is recorded, yielding a transformation pair that maps from the old to the new state. The transformation pair can include context information, such as the words appearing before and after the text that changed. By analyzing the transformation pairs, the present invention learns from the user's own corrections and revisions.

The present invention may learn exceptions to spelling and grammar correction rules when the transformation pair undoes the effect of the spelling and grammar correction systems. Exceptions to any spelling and grammar correction system may be learned without accessing the internals of the correction system in order to suspend or reverse its operation in exceptional cases.

The present invention may learn a new rule when the user makes changes to text that was not modified by the existing rules or when the changes do not undo the modifications executed by the rules.

The present invention may learn a correction rule when the old text was not a valid word and the new text is a valid word. It may be aggressive in its learning behavior, learning correction rules for any change no matter how large. It may also be conservative, requiring changes to be small before it learns a correction rule. It may learn a rule that is restricted to just the transformation it recorded. It may also analyze the transformation to extract a more general rule.

The present invention may learn correction rules that are not limited to just dictionary words, but also include names and punctuation. For example, if the user frequently misspells someone's name, the user only needs to correct the error once for the present invention to learn to correct the error automatically in the future. Likewise, the present invention may learn punctuation correction rules by observing the user's own corrections, rather than by being explicitly instructed.

The present invention may learn correction rules that reflect the user's personal preferences, not the prescriptive dictates of an authority. If the user likes to spell her name as “Michele” instead of “Michelle”, the invention can quickly learn this preference instead of blindly changing the user's text against her wishes.

The present invention may detect transformations that introduce errors by transforming a valid word into an invalid word. It may use this as an opportunity to educate the user about correct usage. If the user then undoes the transformation, it may avoid learning an incorrect rule. It may also require explicit confirmation from the user before learning a rule it believes to be incorrect. However, if the user stubbornly insists on the incorrect usage, the present invention may learn a rule reflecting this change. This allows the present invention to provide consistency in usage and to adapt to the user's wishes. If the user later decides to revert to standard usage, the incorrect rule that was learned may be removed.

The present invention may learn preferences when the new text is a valid word and the old text is also a valid word. In this situation, the present invention uses the context of the transformation to restrict the application of the preference rules. The relationship between the words may be used to identify the type of preference. When the words are synonyms, diction preferences may be learned. When the changes involve tenses, complementary changes may be performed (e.g., if the user inserts the word “was” before “worked”, “worked” maybe changed to “working”), and an offer to change tenses throughout the document may be presented. In other cases, grammar correction rules may be learned, such as the difference between “affect” and “effect” or “its” and “it's”.

The present invention may learn context-sensitive rules. The context in which a change occurs may be recorded, so that ambiguous changes may include context restrictions to disambiguate the change. When a transformation reverses the effect of a previously learned rule, the user may be presented with several options, such as: removing the old rule, specializing the new and/or old rules based on context, ignoring the transformation, and/or undoing the transformation.

The present invention may learn rules to correct word-boundary errors (i.e., when a transformation affects two adjacent words). Word boundary errors include splits (an extra space added in the middle of a word), merges (a space missing between two words), and traveling (one or more characters moved from one word to the next, as in “th edog”).

After the present invention learns a new rule, the new rule may be automatically executed throughout the document. This allows the user to correct an error in one location and have it automatically corrected throughout the rest of the document. If preferred, a prompt may ask the user for permission before executing the change, or a search and replace dialog box may be invoked.

The present invention allows word processing programs to become more of an intelligent assistant than a recording device. An intelligent assistant learns from its mistakes. When an error made by an intelligent assistant is corrected, the intelligent assistant avoids similar errors in the future, suggests complementary changes, and learns to predict the style preferred by the user. An intelligent assistant deduces the user's intentions and uses that information to guide its behavior in the future.

The present invention may be applied to spelling and grammar correction, synonym substitution, diction improvement, and tense and politeness correction. The present invention is not limited to word processing programs, but works with any text processing application, including machine translation, optical character recognition (OCR) software, and help systems. In a machine translation application, when the user corrects translation errors, that information can be provided to the translation engine to improve the engine and allow the learning of additional translation rules. In OCR applications, when the user corrects OCR errors, that information can be used to improve the accuracy of the OCR algorithm on the rest of the document and on future documents from the same source. With a help system, the nature of the transformations can be used to invoke help prompts, if necessary. For example, if the user performs a synonym substitution, the help system can suggest other synonyms that may be of interest. If the user introduces a spelling or grammatical error, the help system can educate the user about proper usage and display helpful tips.

### BRIEF DESCRIPTION OF THE DRAWINGS

FIG. 1 is a flow diagram of a first embodiment of a method according to the present invention;

FIG. 2 is a flow diagram of a second embodiment of a method according to the present invention;

FIG. 3 is a flow diagram of a third embodiment of a method according to the present invention;

FIG. 4 is a flow diagram of a fourth embodiment of a method according to the present invention;

FIG. 5 is a flow diagram of a fifth embodiment of a method according to the present invention;

FIGS. 6A and 6B are flow diagrams of a sixth embodiment of a method according to the present invention;

FIG. 7 is a flow diagram of a seventh embodiment of a method according to the present invention;

FIG. 8 is a flow diagram of an eighth embodiment of a method according to the present invention;

FIG. 9 is a flow diagram of a ninth embodiment of a method according to the present invention; and

FIG. 10 is a schematic drawing of an apparatus according to the present invention.

### DESCRIPTION OF THE PREFERRED EMBODIMENTS

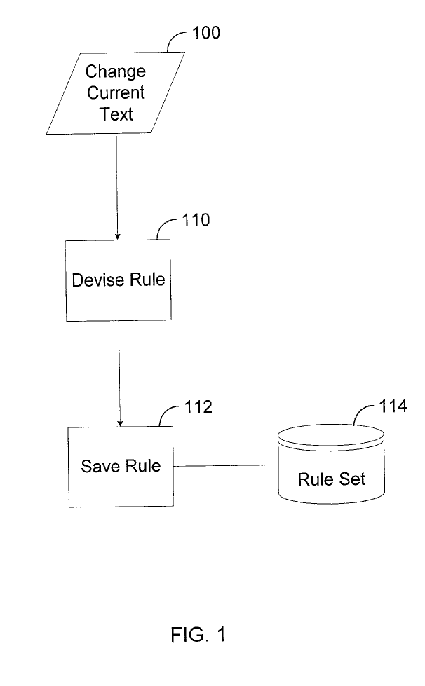

Referring to FIG. 1, a first embodiment of a method according to the present invention begins at step 100 when a user changes current text into transformed text. Based upon the changes, a rule is devised in step 110. The rule may be devised automatically upon the user making changes in step 100. The changes may be detected by intercepting cursor movements and text modification events. Step 112 saves the devised rule in a rule set 114 for future use.

The rule may also be based on the context in which the changes occurred. The context may include text surrounding the current text or may be dependent on whether the current text and the transformed text are in a dictionary. If the current text and the transformed text are both in a dictionary and are synonyms, context-sensitive constraints may be included in the devised rule based upon the user's preference for the transformed text, as evidenced by the user's changes in step 110.

If the changes made by the user undo the effect of a previously executed rule from the rule set, the rule may be saved as an exception to the previously executed rule. If the devised rule conflicts with a previously devised rule, context-sensitive constraints may be added to the devised rule to disambiguate the devised rule from the previously devised rule. Alternatively, context-sensitive constraints may be added to the previously devised rule to disambiguate the devised rule from the previously devised rule. Changes made by the user may affect a name, for example, the spelling of the name, the title used with the name, or pronouns used with the name.

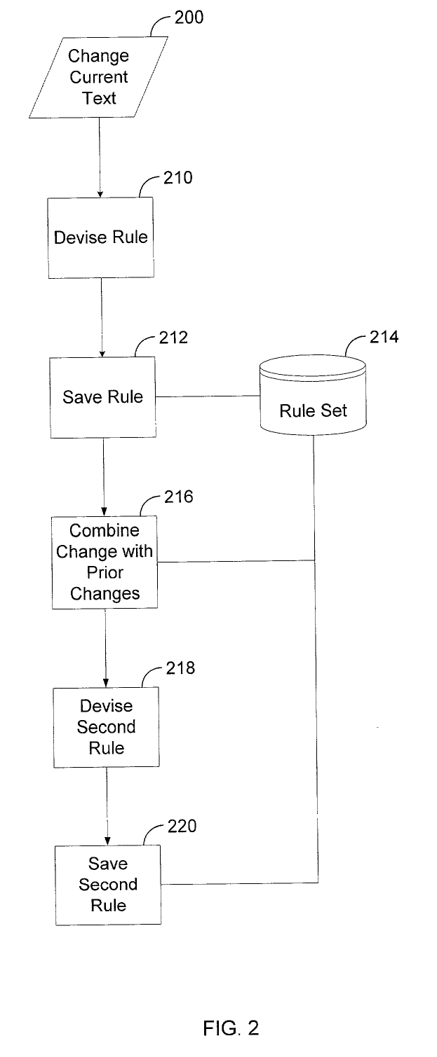

Referring to FIG. 2, a second embodiment of a method according to the present invention begins at step 200 when a user changes current text into transformed text. Based upon the changes, a rule is devised in step 210. Step 212 saves the devised rule in a rule set 214 for future use. The changes are combined with prior changes in step 216. A second rule is devised in step 218 based on the combination of changes. Step 220 saves the second rule to the rule set 214.

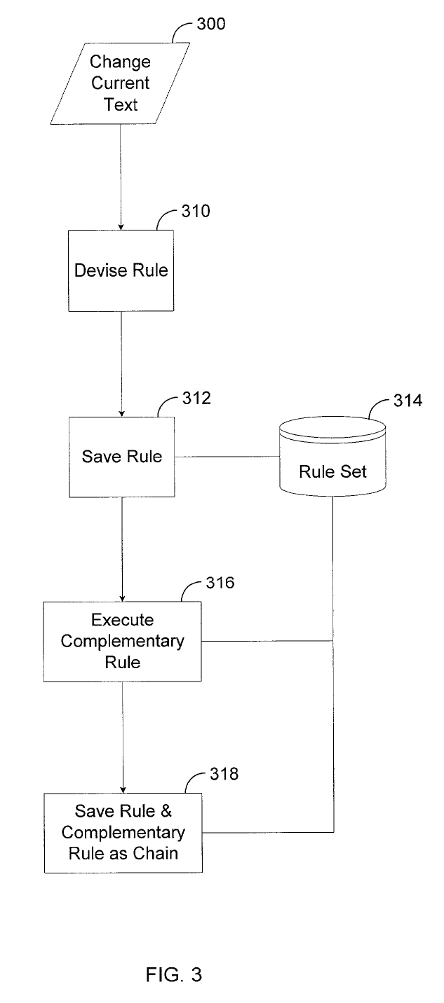

A third embodiment of the present invention is illustrated in FIG. 3. A user changes current text into transformed text at step 300. Based upon the changes, a rule is devised in step 310. Step 312 saves the devised rule in a rule set 314 for future use. Step 316 executes at least one other rule from the rule set which is complementary to the devised rule. The at least one other rule may have similar sequences of adjacent changes as the devised rule. Step 318 may save the at least one other rule and the devised rule together as a chain of complementary rules in the rule set 314 for future use.

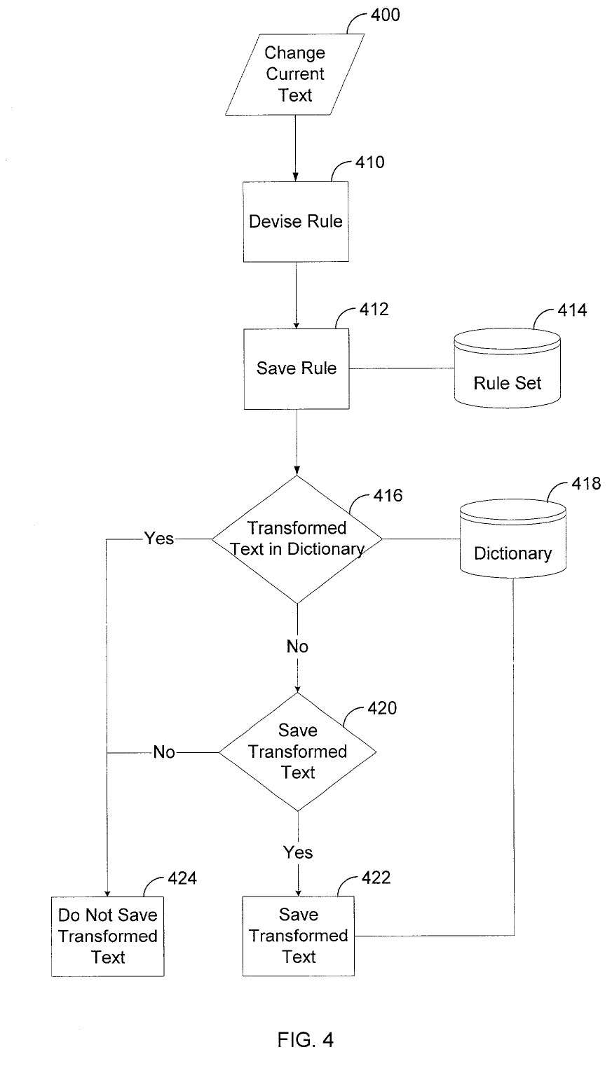

Referring to FIG. 4, a fourth embodiment of a method according to the present invention begins at step 400 when a user changes current text into transformed text. Based upon the changes, a rule is devised in step 410. Step 412 saves the devised rule in a rule set 414 for future use. Step 416 determines whether the transformed text is in a dictionary 418. If the transformed text is not in the dictionary 418, a prompt may be provided to the user in step 420 to gain permission to save the transformed text in the dictionary 418. If permission is given, step 422 saves the transformed text to the dictionary 418. If in step 416 the transformed text is in the dictionary 418, step 424 does not save the transformed text to the dictionary 418. Likewise, if permission is not given in step 420, step 424 does not save the transformed text to the dictionary 418.

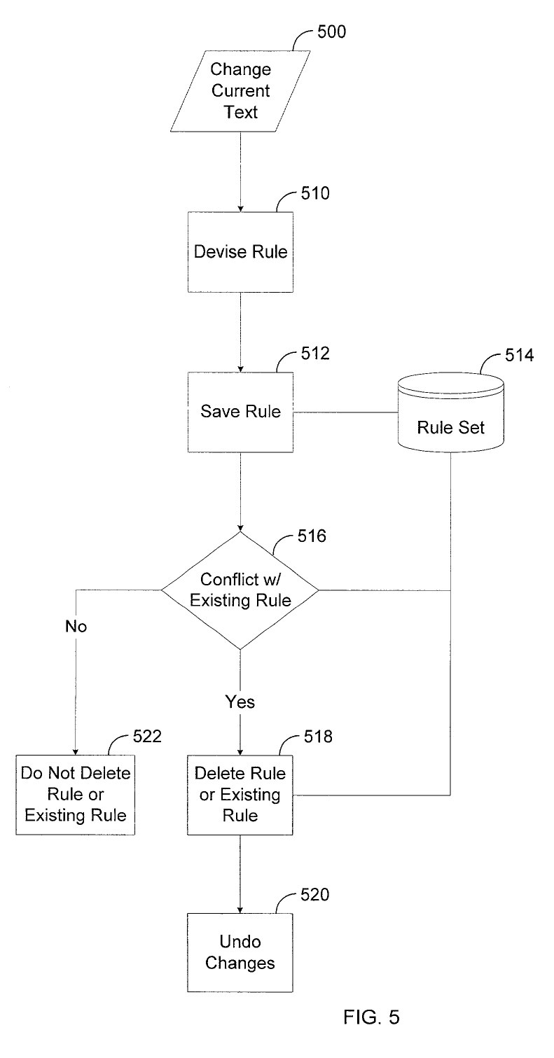

A fifth embodiment of the present invention is illustrated in FIG. 5. A user changes current text into transformed text in step 500. Based upon the changes, a rule is devised in step 510. Step 512 saves the devised rule in a rule set 514 for future use. Step 516 determines whether the devised rule conflicts with an existing rule in the rule set 514. If so, step 518 deletes either the devised rule or the existing rule from the rule set 514. Step 520 may be invoked to undo the changes that the user made in step 500. If in step 516 the devised rule does not conflict with an existing rule, step 522 does not delete either the devised rule or the existing rule from the rule set 514.

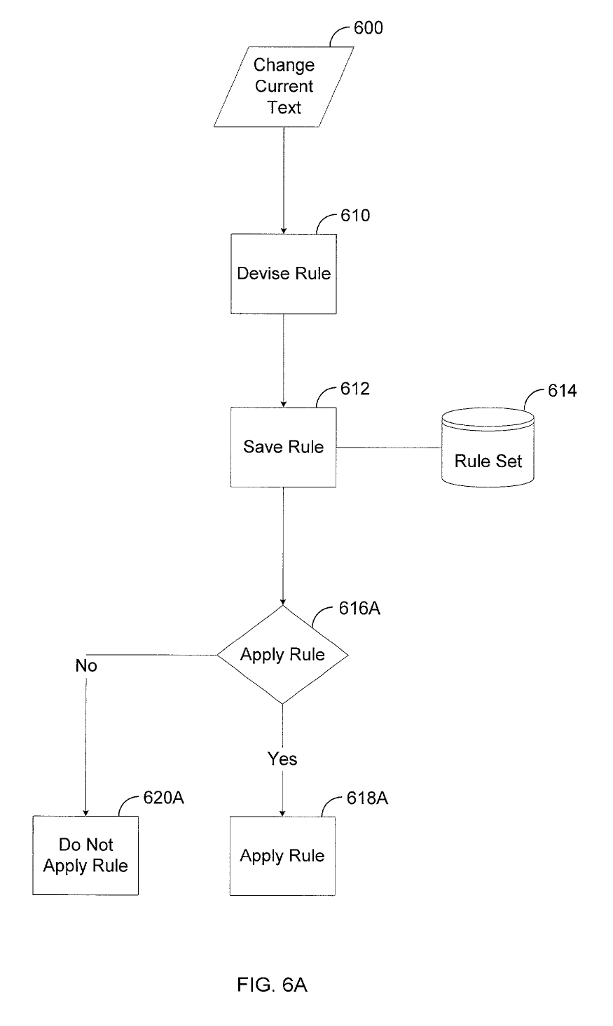

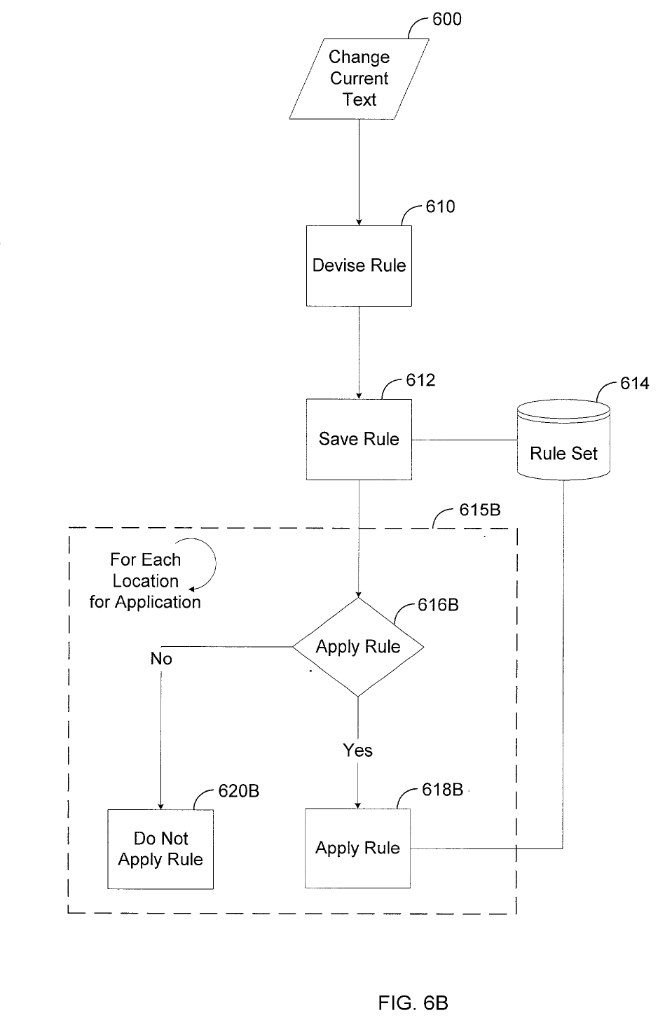

A sixth embodiment of the present invention is illustrated in FIGS. 6A and 6B. Referring to FIG. 6A, a user changes current text into transformed text in step 600. Based upon the changes, a rule is devised in step 610 in a rule set 614 for future use. Step 616A requests permission from the user to apply the rule to the rest of the document. If the user gives permission, step 618A applies the devised rule. If the user does not give permission in step 616A, step 620A does not apply the rule. Step 618A may apply the devised rule throughout the rest of the document without the performance of step 616A.

FIG. 6B illustrates a variation of the embodiment in FIG. 6A. Loop 615B iterates for each potential application of the devised rule in the remaining portions of the document. For each location of application of the rule, step 616B requests permission to apply the devised rule at that location. If the user gives permission, step 618B applies the devised rule. If the user does not give permission, step 620B does not apply the rule. Loop 615B continues with the next location within the document where the devised rule may be applied. If the user selectively gives permission for some, but not all of the applications of the devised rule, context-sensitive constraints may be included in the devised rule based on the user's selective application of the devised rule.

The present invention may be applied to an optical character recognition system, a handwriting recognition system, a machine translation system, a speech processing system, or a speech understanding system. The present invention may also be applied to a punctuation recovery system where, for example, the changes made by the user affect punctuation.

The present invention may be applied to a text processing system, for example, a spelling correction system or a grammar correction system. The changes made by the user may affect more than one word, for example, in the correction of word boundary errors. The rule set in the text processing system may be in a dictionary. The changes made by the user may be used to update costs in a candidate generation spelling correction method such that a list of candidate corrections and the order in which the candidate corrections are presented more closely reflect a user's preferences.

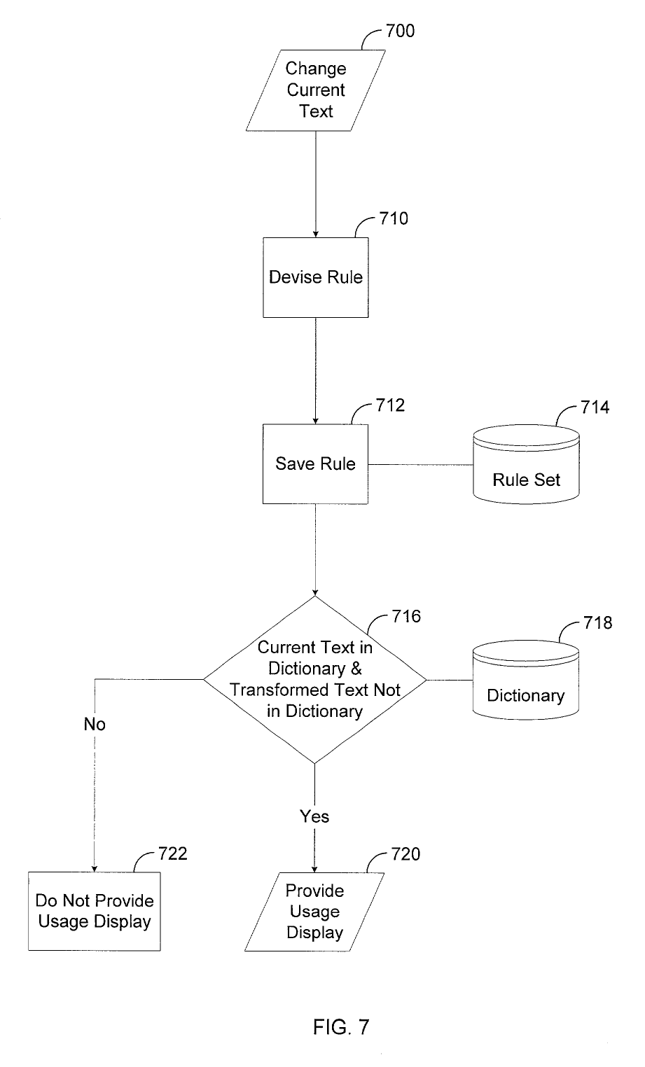

A seventh embodiment of the present invention is illustrated in FIG. 7 for use with a text processing system. A user changes current text into transformed text in step 700. Based upon the changes, a rule is devised in step 710. Step 712 saves the devised rule in a rule set 714 for future use. Step 716 determines whether the current text is in a dictionary 718 and the transformed text is not in the dictionary 718. If so, step 720 provides a dialog box to the user which displays information about the proper usage of the current text. If not, step 722 does not provide a dialog box to the user.

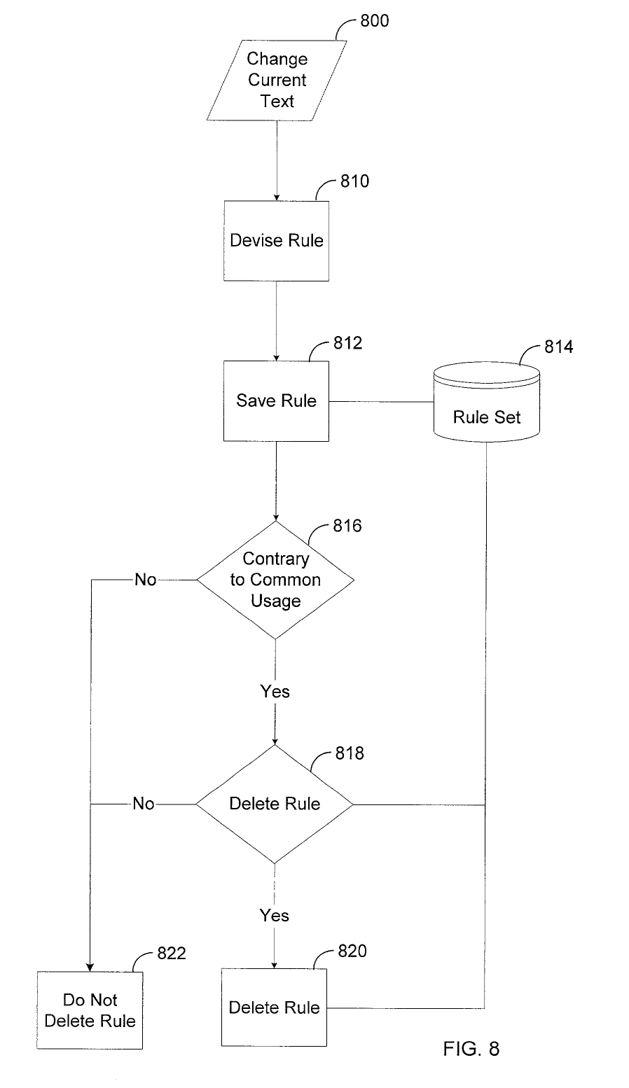

An eighth embodiment of the present invention is illustrated in FIG. 8 for use with a text processing system. A user changes current text into transformed text in step 800. Based upon the changes, a rule is devised in step 810. Step 812 saves the devised rule in a rule set 814 for future use. Step 816 determines whether the devised rule is contrary to common usage. If so, step 818 requests permission from the user to delete the devised rule from the rule set 814. If permission is given, step 820 deletes the devised rule from the rule set 814. If in step 816 the devised rule is not contrary to common usage, step 822 does not delete the devised rule from the rule set 814. Likewise, if permission is not given in step 818, step 822 does not delete the devised rule from the rule set 814.

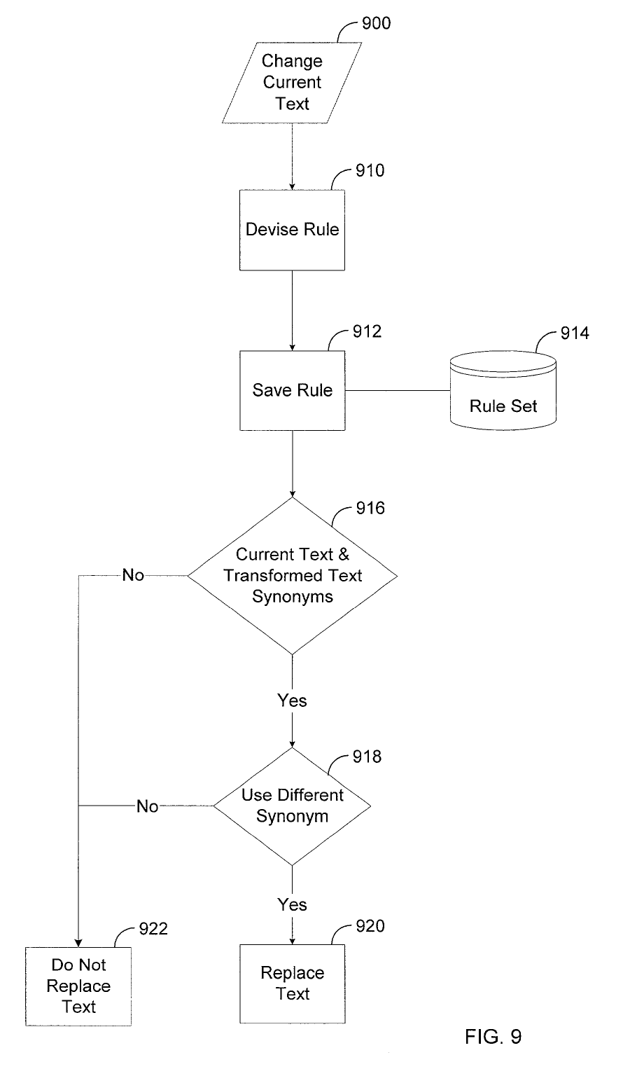

A ninth embodiment of the present invention is illustrated in FIG. 9 for use with a text processing system. A user changes current text into transformed text in step 900. Based upon the changes, a rule is devised in step 910. Step 912 saves the devised rule in a rule set 914 for future use. Step 916 determines whether the current text and the transformed text are synonyms. If so, step 918 displays a list of synonyms of the current text and the transformed text and prompts the user to select to keep the transformed text or substitute a synonym from the list for the transformed text. If a synonym is selected, step 920 replaces the transformed text with the selected synonym. If in step 916 the current text and the transformed text are not synonyms, step 922 does not replace the transformed text. Likewise, if a different synonym is not selected in step 918, step 922 does not replace the transformed text.

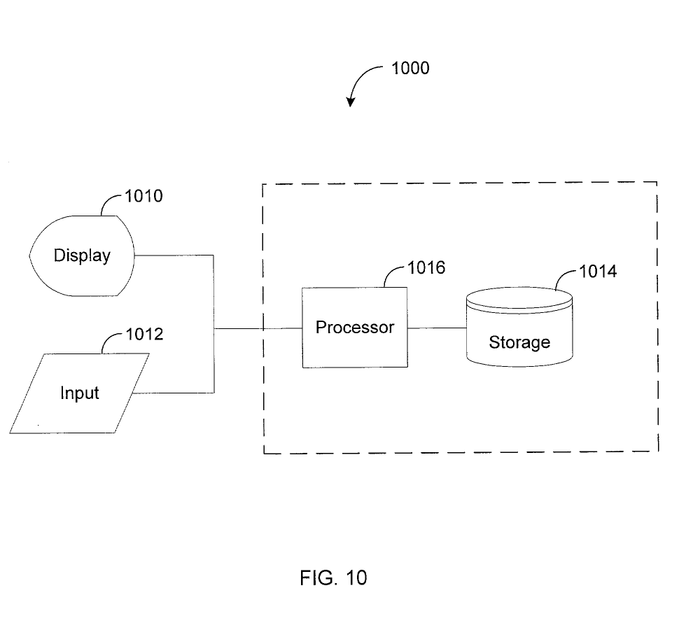

FIG. 10 illustrates an apparatus of the present invention capable of enabling the methods of the present invention. A computer system 1000 is utilized to enable the method. The computer system 1000 includes a display unit 1010 and an input device 1012. The input device 1012 may be any device capable of receiving user input, for example, a keyboard or a scanner. The computer system 1000 also includes a storage device 1014 for storing the method according to the present invention and for storing the text to be changed. A processor 1016 executes the method stored on storage device 1014. The processor is also capable of sending information to the display unit 1010 and receiving information from the input device 1012. Any type of computer system having a variety of software and hardware components which is capable of enabling the methods according to the present invention may be used, including, but not limited to, a desktop system, a laptop system, or any network system.

The present invention was incorporated in the C programming language into a spelling and handwriting correction system for the “Palm Pilot”. The “Palm Pilot” is a hand-held computer with a handwriting interface. On the face of the display of the “Palm Pilot”, there is provided a space for hand forming characters that are then translated and displayed. The spelling correction system intercepts the characters entered by the user and uses a variety of rules and heuristics to correct errors in the input.

This correction system includes spelling correction rules that may, at times, be too aggressive for automatically correcting spelling errors. For example, names and abbreviations are sometimes treated as spelling errors. When the user undoes the effect of an automatic correction, the system adds the original uncorrected word to an exception list. The next time the system encounters the word, it overrides the spelling correction rules and leaves the word unmodified. From the user's perspective, the system has learned from the user's correction of the system's errors, improving its accuracy.

The following computer code in the C language sets forth portions of an embodiment of this invention implemented into the correction system for the “Palm Pilot”.

void UndoRule (JotoGlobals *globalsP, FieldPtr fld)

{

| RuleDesc rd = globalsP->savedRule; | |
|---|---|
| Rule | rule = toRule(&rd); |
| Word | iPoint = FldGetInsPtPosition(fld); |
| Word | startPos = globalsP->startPos; |
| Word | rlength = RHSLength(rule); |
| CharPtr | saved = globalsP->Saved; |
| Word | llength = StrLen(saved); |

SndPlaySystemSound(sndClick);
FldDelete (fld, startPos, StartPos+rlcngth);
FldSetInsertionPoint (fld, startPos);
FldInsert (fld, saved, llength);
FldSetInsertion Point (fld, iPoint + (rlength − llength));
if (charType(saved[llength−1]) == C_WORDBREAK) {

AddUndidToWhiteList(globalsP, fld, globalsP->savedWordCC);

} else {

SetUndidRule(globalsP, true);

}
SetStartPos(globalsP, 0);
SetEndPos(globalsP, 0);
SetSavedRule(globalsP, 0);

}
void AddUndidToWhiteList (JotoGlobals *globalsP, FieldPtr fld, SWord nChars) {

Word num = globalsP->numWhiteList;
if (globalsP->BAddCorrections &&

(num < 32) && (nChars > 1) && (nChars < 13))

{

| | |
|---|---|
| CharPtr | textP = FldGetTextPtr(fld); |
| Word | iPoint = FldGetInsPtPosition(fld); |
| Word | start = iPoint − nChars − 1; |
| CharPtr | wordP = textP + start; |
| Char | buff[13]; |

StrNCopy(buff, wordP, nChars);
buff[nChars] = 0;
SetWhiteList(globalsP, num, buff);
SetNumWhiteList(globalsP, num + 1);

}

}
(defvar *lastpos* nil)
(defvar *prevword* nil)
(defvar *changes* nil)
(define-key text-mode-map “a” ′my-insert)
(define-key text-mode-map “b” ′my-insert)
(define-key text-mode-map “c” ′my-insert)
(define-key text-mode-map “d” ′my-insert)
(define-key text-mode-map “e” ′my-insert)
(define-key text-mode-map “f” ′my-insert)
(define-key text-mode-map “g” ′my-insert)
(define-key text-mode-map “h” ′my-insert)
(define-key text-mode-map “i” ′my-insert)
(define-key text-mode-map “j” ′my-insert)
(define-key text-mode-map “k” ′my-insert)
(define-key text-mode-map “l” ′my-insert)
(define-key text-mode-map “m” ′my-insert)
(define-key text-mode-map “n” ′my-insert)
(define-key text-mode-map “o” ′my-insert)
(define-key text-mode-map “p” ′my-insert)
(define-key text-mode-map “q” ′my-insert)
(define-key text-mode-map “r” ′my-insert)
(define-key text-mode-map “s” ′my-insert)
(define-key text-mode-map “t” ′my-insert)
(define-key text-mode-map “u” ′my-insert)
(define-key text-mode-map “v” ′my-insert)
(define-key text-mode-map “w” ′my-insert)
(define-key text-mode-map “x” ′my-insert)
(define-key text-mode-map “y” ′my-insert)
(define-key text-mode-map “z” ′my-insert)
(define-key text-mode-map “A” ′my-insert)
(define-key text-mode-map “B” ′my-insert)
(define-key text-mode-map “C” ′my-insert)
(define-key text-mode-map “D” ′my-insert)
(define-key text-mode-map “E” ′my-insert)
(define-key text-mode-map “F” ′my-insert)
(define-key text-mode-map “G” ′my-insert)
(define-key text-mode-map “H” ′my-insert)
(define-key text-mode-map “I” ′my-insert)
(define-key text-mode-map “J” ′my-insert)
(define-key text-mode-map “K” ′my-insert)
(define-key text-mode-map “L” ′my-insert)
(define-key text-mode-map “M” ′my-insert)
(define-key text-mode-map “N” ′my-insert)
(define-key text-mode-map “O” ′my-insert)
(define-key text-mode-map “P” ′my-insert)
(define-key text-mode-map “Q” ′my-insert)
(define-key text-mode-map “R” ′my-insert)
(define-key text-mode-map “S” ′my-insert)
(define-key text-mode-map “T” ′my-insert)
(define-key text-mode-map “U” ′my-insert)
(define-key text-mode-map “V” ′my-insert)
(define-key text-mode-map “W” ′my-insert)
(define-key text-mode-map “X” ′my-insert)
(define-key text-mode-map “Y” ′my-insert)
(define-key text-mode-map “Z” ′my-insert)
(define-key text-mode-map “” ′my-insert-space)
(define-key text-mode-map “\C-t” ′my-transpose-chars)
(defun my-insert (&optional n)

(interactive “p”)
(if(and *lastpos*)

(integerp *lastpos*)
(not (=*lastpos*

(point))))

(newpos *lastpos* (point)))

(self-insert-command n)
(setq *lastpos* (point)))

(defun my-insert-space (&optional n)

(interactive “p”)
(self-insert-command n)
(newpos-space *lastpos* (point))
(setq *lastpos* (point)))

(defun my-transpose-chars (&optional n)

(interactive “p”)
(if(and *lastpos*)

(integerp *lastpos*)
(not (=*lastpos*

(point))))

(newpos *lastpos* (point)))

(transpose-chars n)
(setq *lastpos* (point)))

(defun newpos (old new)

;; We've changed positions by more than a character.
(let ((current nil))
;; Grab the current word at the old position.

(goto-char old)
(setq current (current-word t))
(goto-char new)
:: Report any changes in this word from the previous version.
(if (and *prevword* current

(not (equal *prevword* current)))

(save-pair *prevword* current)))

;; Then archive the word at the new position for possible changes.
(setq *prevword* (current-word t)))

(defun newpos-space (old new)
;; We just entered a space.
(let ((current nil)

(next nil))

;; Grab the current word at the old position.
(goto-char old)
(setq current (current-word t))
(goto-char new)
;; Grab the current word at the new position.
(setq next (current-word t))
;; Report any changes in this word from the previous version.
(if (and *prevword* current

(not (equal *prevword* current)); unchanged
)

(if (equal *prevword* next)

;; inserted word
(message (format “inserted %s” current))
;; changed word
(save-pair *prevword* current))))

;; Then archive the word at the new position for possible changes.
(setq *prevword* (current-word t)))
(defun save-pair (old new)
(message (format “%s -->%s” old new))
(setq *changes*

(cons (list old new) *changes*)))

(defun insert-changes ()
;; This function inserts the contents of the *changes* variable
;; into the current buffer.
(interactive)
(let ((tmp nil))

(while *changes*

(setq tmp (car *changes*)

*changes* (cdr *changes*))

(insert-string (format “%s --> %s\n” (car tmp) (car (cdr tmp)))))))

;;; *EOF*

The present invention was also implemented in the GNU-Emacs text editor to monitor the user's editing behavior and save the transformations whenever they occurred.

The following computer code in the Lisp language sets forth portions of an embodiment of this invention implemented into GNU-Emacs.

This code tracks changes made by the user to previously written text, allowing the code to learn spelling correction rules from the user. A demonstration of tracking changes (before and after) for insertions and transpositions was implemented. Deletions are demonstrated by Joto, and substitutions are not normally applicable to GNU-Emacs.

Because GNU-Emacs does not provide access to the internal cursor movement functions, it was necessary to monitor cursor movement by instrumenting the keypresses. When the user types a letter or executes a control key sequence, GNU-Emacs executes a function. For example, when the user types the letter ‘a’, it executes the function SELF-INSERT-COMMAND to insert the letter into the buffer at the current cursor position. When the user types CTRL-T, it executes the function TRANSPOSE-CHARS to transpose the characters before and after the current cursor position. Definitions were substituted for the letters ‘a’ through ‘z’ (upper and lower case), space, and CTRL-T to do some extra work before calling the original definition of the key. Re-definitions for other whitespace characters, non-alphabetic characters, deletions, and other control key sequences were not included, since the definition would be similar.

For example, the replacement definition for SELF-INSERT-COMMAND checks whether the current cursor position (called the “point” in GNU-Emacs terminology) is the same as the previous cursor position, as stored in the global variable *LASTPOS*. Remember that this function has executed before, so the cursor position should be the same, unless the user changed the cursor position between this keystroke and the previous keystroke. If the cursor position has changed, the function NEWPOS is executed with the old and new positions as arguments. Then the original SELF-INSERT-COMMAND function is executed, and the value of *LASTPOS* is updated to the new cursor position. The replacement for TRANSPOSE-CHARS is similar, except it calls TRANSPOSE-CHARS instead of SELF-INSERT-COMMAND. The definition for space is similar to the definition for other alphabetic characters, except that it does not need to check whether the cursor position has changed and it calls NEWPOS-SPACE instead of NEWPOS.

The NEWPOS function grabs the current word at the old position and compares it with the value of the global variable *PREVWORD*. This variable was set to the then-current word at the old position just after the previous change in cursor position moved the cursor to that word and before any changes were made to the word. Thus, the *PREVWORD* variable contains the “before” part of the transformation, and the current word at the old position is the“after” part of the transformation. If they are different, it saves the transformation and displays the transformation as a temporary message in the status line. It then sets the *PREVWORD* variable to the word at the new position, preparing for the next invocation of this function.

The NEWPOS-SPACE function is similar, except that it has to distinguish inserted words from changed words. If a new word was inserted, then the word at the new position will be the same as the word previously stored in the *PREVWORD* variable. If so, the function reports that a word was inserted and does not save a transformation pair.

In a word processing application, the implementation would be much simpler and more direct by instrumenting the cursor movement functions. Rather than redefining the alphanumeric characters to indirectly monitor cursor movement, the word processing application could monitor cursor movement directly by executing a function similar to the NEWPOS function after any cursor movement. After the insertion of any whitespace characters, such as a space, tab, or carriage return, a function similar to the NEWPOS-SPACE function would be executed. There would be no need to execute special functionality after the execution of deletion, transposition, substitution, text selection, and similar text modification functions, because any changes introduced by those functions would be detected by the cursor movement and whitespace functions. Nothing prevents the addition of such functions to allow the capture of changes on a finer scale, as done for TRANSPOSE-CHARS. The program could also look for changes after a certain amount of idle time, instead of waiting until cursor movement occurs.

Given a transformation pair, the word processing application could easily extract the words that occur before and after the affected text for inclusion in a rule. It could also use knowledge of the properties of the affected text to decide the nature of the rule to be learned. For example, if the affected text had been automatically corrected and the new text reversed the automatic correction, then the new text could be added as an exception to the automatic correction rules triggered by the new text. If a dictionary lookup on the before and after parts of the transformation showed that the old text was not in the dictionary but the new text was, then a new automatic correction rule could be learned.

The present invention should be easy to implement as part of any word processing program.

It will be understood by those skilled in the art that while the foregoing description sets forth in detail preferred embodiments of the present invention, modifications, additions, and changes may be made thereto without departing from the spirit and scope of the invention. Having thus described our invention with the detail and particularity required by the Patent Laws, what is desired to be protected by Letters Patent is set forth in the following claims.

We claim:

1. A computer-assisted method for learning from a user's manipulations to text in a document, comprising the steps of:
changing current text into transformed text,
devising a rule based on the changes to the current text, and
saving the rule in a rule set for future use.

2. The method according to claim 1, wherein the changes are detected by intercepting cursor movements and text modification events.

3. The method according to claim 1, wherein the rule is devised automatically.

4. The method according to claim 1, wherein the rule is devised also based on the context in which the changes occurred.

5. The method according to claim 4, wherein the context includes text surrounding the current text.

6. The method according to claim 4, wherein the context includes whether the current text and the transformed text are in a dictionary.

7. The method according to claim 1, wherein if the changes undo the effect of a previously executed rule from the rule set, the rule is saved as an exception to the previously executed rule.

8. The method according to claim 1, wherein if the current text and the transformed text are both in a dictionary and are synonymous, context-sensitive constraints are included in the rule based upon the user's preference for the transformed text.

9. The method according to claim 1, wherein if the rule conflicts with a previous rule, context-sensitive constraints are added to the rule to disambiguate the rule from the previous rule.

10. The method according to claim 1, wherein if the rule conflicts with a previous rule, context-sensitive constraints are added to the previous rule to disambiguate the rule from the previous rule.

11. The method according to claim 1, wherein the changes affect a name.

12. The method according to claim 11, wherein spelling of the name is corrected.

13. The method according to claim 11, wherein a title usage in relation to the name is corrected.

14. The method according to claim 11, wherein a pronoun reference in relation to the name is corrected.

15. The method according to claim 1, further including the steps of:
combining the changes with prior changes,
devising a rule based upon the combination of changes, and
saving the rule in a rule set for future use.

16. The method according to claim 1, further including the step of executing at least one other rule from the rule set which is complementary to the rule.

17. The method according to claim 16, wherein the at least one other rule has similar sequences of adjacent changes as the rule.

18. The method according to claim 16, further including the step of saving the at least one other rule and the rule as a chain of complementary rules for future use.

19. The method according to claim 1, further including the step of if the transformed text is not in a dictionary, adding the transformed text to the dictionary.

20. The method according to claim 19, further including the steps of:
providing to the user a prompt that requests permission to add the transformed text to the dictionary, and
if permission is given, adding the transformed text to the dictionary.

21. The method according to claim 1, further including the step of if the rule conflicts with a previous rule, deleting the previous rule.

22. The method according to claim 21, further including the step of undoing the changes.

23. The method according to claim 1, further including the step of if the rule conflicts with a previous rule, deleting the rule.

24. The method according to claim 23, further including the step of undoing the changes.

25. The method according to claim 1, further including the step of applying the rule throughout the document.

26. The method according to claim 25, further including the steps of:
providing to the user a prompt that asks for permission to apply the rule throughout the document, and
if permission is given, applying the rule throughout the document.

27. The method according to claim 25, further including the steps of:
providing to the user a prompt at each proposed application of the rule which asks for permission to apply the rule at the proposed application, and
if permission is given, applying the rule.

28. The method according to claim 27, wherein if the user selectively gives permission for some, but not all, of the applications of the rule, context-sensitive constraints are included in the rule based on the user's selective application of the rule.

29. The method according to claim 1, wherein the method is applied to an optical character recognition system.

30. The method according to claim 1, wherein the method is applied to a handwriting recognition system.

31. The method according to claim 1, wherein the method is applied to a machine translation system.

32. The method according to claim 1, wherein the method is applied to a speech processing system.

33. The method according to claim 1, wherein the method is applied to a speech understanding system.

34. The method according to claim 1, wherein the method is applied to a punctuation recovery system.

35. The method according to claim 34, wherein the changes affect punctuation.

36. The method according to claim 1, wherein the method is applied to a text processing system.

37. The method according to claim 36, wherein the text processing system is a spelling correction system.

38. The method according to claim 36, wherein the text processing system is a grammar correction system.

39. The method according to claim 36, wherein the changes affect more than one word.

40. The method according to claim 39, wherein the changes correct word boundary errors.

41. The method according to claim 36, wherein the rule set is in a dictionary.

42. The method according to claim 36, wherein the changes are used to update costs in a candidate generation spelling correction method such that a list of candidate corrections and the order in which the candidate corrections are presented more closely reflect a user's preferences.

43. The method according to claim 36, further including the step of, if the current text is in a dictionary and the transformed text is not in the dictionary, providing to the user a dialog box that displays information about proper usage of the current text.

44. The method according to claim 36, further including the steps of:
if the rule is contrary to common usage, providing to the user a prompt that requests permission to delete the rule, and
if permission is given, deleting the rule.

45. The method according to claim 36, further including the step of, if the current text and the transformed text are synonyms, providing a prompt to the user which displays a list of synonyms of the current text and the transformed text and requests the user to select to keep the transformed text or substitute a synonym from the list of synonyms for the transformed text.

46. An apparatus to enable a method for learning from a user's manipulations to text in a document, comprising:
means for changing current text into transformed text,
means for devising a rule based on the changes to the current text, and
means for saving the rule in a rule set for future use.
